(19) United States
(12) Patent Application Publication
(10) Pub. No.: US 2019/0154440 A1
(43) Pub. Date: May 23, 2019

(54) SYSTEMS AND METHODS FOR EVALUATING UNDERGROUND ROAD CONDITIONS USING ACCELEROMETERS

(71) Applicant: Joy MM Delaware, Inc., Wilmington, DE (US)

(72) Inventor: Wilhelmus Hendrickus Theunissen, Centurion, Gauteng (ZA)

(73) Assignee: Joy MM Delaware, Inc., Wilmington, DE (US)

(21) Appl. No.: 15/571,394

(22) PCT Filed: May 4, 2016
(86) PCT No.: PCT/US16/30692

§ 371 Date: Nov. 2, 2017

Related U.S. Application Data
(60) Provisional application No. 62/156,495, filed on May 4, 2015.

(51) Int. Cl. G01B 21/30; B60T 8/172; G01P 15/08

(52) U.S. Cl. CPC G01B 21/30; B60T 2210/10; G01P 15/0891; B60T 8/172

(57) ABSTRACT

Methods and systems for evaluating underground road conditions using accelerometers. One system includes an electronic processor that receives sensor data from an accelerometer and location data of a mining machine operating within a mining environment. The electronic processor determines, based on the sensor data, a first data point when acceleration in a first direction exceeds a predetermined first threshold based on the sensor data, and determines a second data point when acceleration in a second direction opposite the first direction exceeds a predetermined second threshold. The electronic processor also determines a location of a road condition associated with the first data point and the second data point based on the location data and takes at least one automatic action to correct the road condition.

### RELATED APPLICATIONS

This application claims priority to U.S. Provisional Patent Application No. 62/156,495 filed on May 4, 2015, the entire content of which is incorporated herein by reference.

### FIELD

Embodiments of the invention relate to systems and methods for evaluating road conditions in underground mining environments.

### BACKGROUND

Underground vehicles and mobile mining machinery (i.e., “equipment”) travel into and out of a mine as well as in mining areas. In some embodiments, poor road conditions may be masked by water, mud, debris (e.g., coal or other minerals), and/or a lack of illumination. Therefore, poor road conditions might not always be readily detectable and, thus, mine personnel responsible for road maintenance might not be aware of or informed about poor road conditions.

Poor or deteriorated roads conditions may have a detrimental effect on the equipment using the road. These effects may include reduced service life of components, more frequent breakdowns and downtimes, and increased maintenance costs. For example, equipment using a road that is in a poor condition is exposed to more severe shock and vibration loads and, therefore, might suffer reduced component life and more frequent breakdowns than equipment used on better roads. This, in turn, increases maintenance costs, reduces component and machine life, and decreases production and production efficiency.

Also, to manage deteriorating road conditions or address poor conditions, mining personnel are typically required to inspect roads and detect poor conditions (e.g., potholes, steps, etc.) or rely on other personnel to report bad road conditions. In addition, mining personnel are often required to routinely maintain roads to hopefully prevent poor conditions from occurring. Using personnel for these tasks, however, increases mining costs.

The comparative analysis between costs associated with poor road conditions and (decreased) costs associated with good road conditions is not generally known as there are no accurate, inexpensive, and repeatable mechanisms for benchmarking or evaluating road conditions. Therefore, some mining operations do not invest in road maintenance or repair efforts since there is no supporting data to justify spending money to improve road conditions.

### SUMMARY

Accordingly, embodiments of the invention provide methods and systems for evaluating road conditions in underground mining environments. In one system, mobile equipment used in underground mining environments are equipped with one or more micro electro-mechanical systems (“MEMS”) accelerometers, which may be used to determine a condition of a road. For example, vertical (i.e., up and down) acceleration reported by the accelerometers may be indicative of the vertical shock or impact that the equipment is exposed to on the road. This shock may be based on the speed of the equipment, road conditions, and the state of the equipment's suspension system. Accordingly, the shock data may be used to determine conditions of the road and to detect poor road conditions, which may include, among other conditions, pot-holes, steps in the roadway, and other undulations.

For example, one embodiment provides a system including an accelerometer coupled to a mining machine and an electronic processor. The electronic processor is configured to receive sensor data from the accelerometer and receive location data associated with the mining machine. The electronic processor is also configured to determine a first data point when acceleration in a first direction exceeds a predetermined first threshold based on the sensor data, determine a second data point when acceleration in a second direction opposite the first direction exceeds a predetermined second threshold based on the sensor data, determine a location of a road condition represented by the first data point and the second data point based on the location data. In addition, the electronic processor is configured to automatically generate and transmit an electronic notification over at least one communication network, the electronic notification indicating the location.

Another embodiment provides a method of detecting a road condition of an underground mining environment. The method includes receiving, with an electronic processor, sensor data from an accelerometer coupled to a mining machine operating within the underground mining environment, and receiving, with the electronic processor, location data associated with the mining machine generated by position detecting device associated with the mining machine. The method also includes determining, with the electronic processor, a first data point when acceleration in a first direction exceeds a predetermined first threshold based on the sensor data, determining, with the electronic processor, a second data point occurring in time after the first data point when acceleration in a second direction opposite the first direction exceeds a predetermined second threshold based on the sensor data, and determining, with the electronic processor, a location of a road condition associated with the first data point and the second data point based on the location data. In addition, the method includes automatically updating, with the electronic processor, a graphical map of the mining machine with an indicator associated with the location of the road condition.

Yet another embodiment provides a method of detecting road conditions within an underground mining environment. The method includes receiving, with an electronic processor, sensor data from an accelerometer coupled to a mining machine operating within the underground mining environment, and receiving, with the electronic processor, location data associated with the mining machine generated by a position detecting device associated with the mining machine. The method also includes determining, with the electronic processor, a metric based on the sensor data, wherein the metric includes a maximum acceleration during a period of time based on the sensor data, an average of accelerations during the period of time, or a number of accelerations above a predetermined threshold during the period of time, and determining, with the electronic processor, a score based on the metric or a derivation of the metric. In addition, the method includes assigning, with the electronic processor, the score to at least a portion of a road within the underground mining environment based on the location data, and outputting, with the electronic processor, the score assigned to the portion of the road.

Other aspects of the invention will become apparent by consideration of the detailed description and accompanying drawings.

### BRIEF DESCRIPTION OF THE DRAWINGS

FIG. 1 schematically illustrates a system for determining a road condition according to one embodiment.

FIG. 2 schematically illustrates a controller included in the system of FIG. 1 according to one embodiment.

FIG. 3 is a flow chart illustrating a method of detecting a road condition performed by the controller of FIG. 2 according to one embodiment.

FIG. 4 schematically illustrates an accelerometer secured to a mining machine travelling on a road.

### DETAILED DESCRIPTION

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and may include electrical connections or couplings, whether direct or indirect. Also, electronic communications and notifications may be performed using any known means including direct connections, wireless connections, etc.

It should also be noted that a plurality of hardware and software based devices, as well as a plurality of different structural components may be utilized to implement the invention. It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “controller” and “control unit” described in the specification may include one or more processors, one or more memory modules including non-transitory computer-readable medium, one or more input/output interfaces, and various connections (e.g., a system bus) connecting the components.

As noted above, embodiments of the invention provide methods and systems for using accelerometers, such as micro electro-mechanical systems (“MEMS”) accelerometers, secured to mobile underground mining equipment to detect road conditions within an underground mining environment. In particular, embodiments of the invention use data generated by the accelerometers (i.e., “accelerometer sensor data” or “sensor data”) to analyze the magnitude, duration, and reoccurrence of shock and impact experienced by the equipment and equate this information into road conditions.

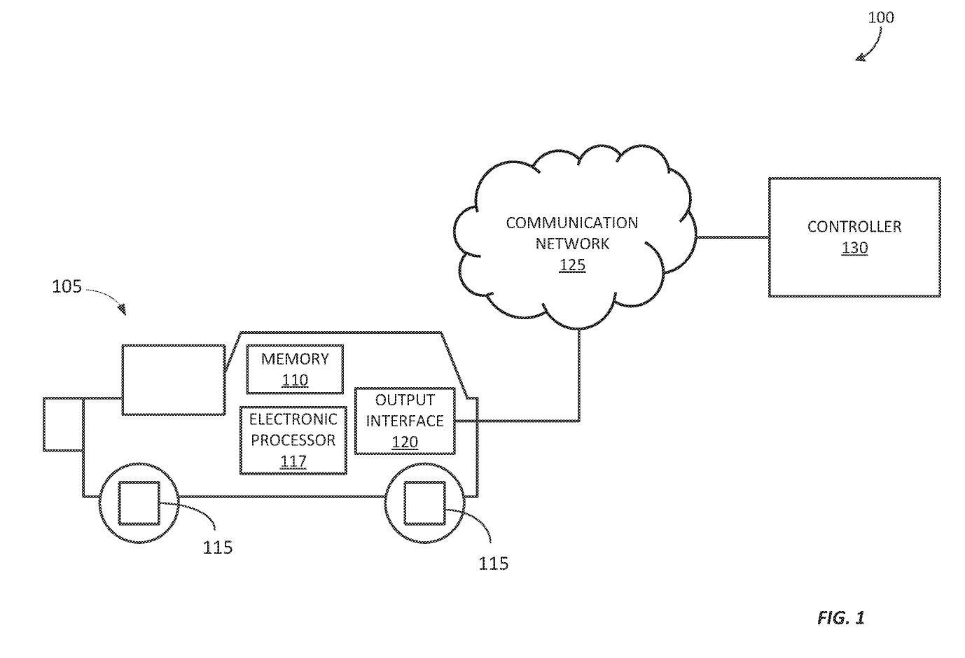

FIG. 1 schematically illustrates a system 100 for detecting a road condition according to one embodiment. The system 100 includes a mining machine 105. The mining machine 105 may be a continuous miner, a drill, a loader, a truck, and the like. The mining machine 105 includes a memory 110, an accelerometer 115, an electronic processor 117, and an output interface 120 that are connected by and communicate through one or more communication lines (not shown). The mining machine 105 may include fewer, additional, or different components than as illustrated in FIG. 1. For example, in some embodiments, the mining machine 105 includes a plurality of accelerometers, a plurality of memories, a plurality of output interfaces, or a combination thereof. Also, in some embodiments, the output interface 120, the memory 110, the electronic processor 117, or a combination thereof may be included in the accelerometer 115.

The accelerometer 115 generates sensor data indicating an amount of acceleration in one or more directions or axes (e.g., a magnitude and direction of acceleration). For example, in some embodiments, the accelerometer 115 generates sensor data representing acceleration in two directions or axes (e.g., up and down). In other embodiments, the accelerometer 115 reports acceleration in three or more directions or axes (e.g., up and down, left and right, front and back, or combinations thereof). The acceleration in a particular direction may be associated with a normal or “at rest” value. Accordingly, a deviation from this value indicates that the mining machine 105 is accelerating in a particular direction. For example, a deviation from a normal or “at rest” value in the vertical axis indicates that the mining machine 105 is vertically accelerating (e.g., accelerating upward or downward). As described below, the magnitude, duration, and frequency of detected accelerations may indicate a severity of the impact or shock on the mining machine 105. In some embodiments, the accelerometer 115 is a MEMS accelerometer, which may include a cantilever beam and a proof or seismic mass. In some embodiments, the one or more accelerometers 115 are coupled to an underside of the mining machine 105.

In some embodiments, the accelerometer 115 may include a plurality of accelerometers installed on a wheel or wheel unit of the mining machine 105. For example, as illustrated in FIG. 1, an accelerometer 115 may be fitted to one or more wheel units of the mining machine 105. In some embodiments, an accelerometer 115 is fitted each wheel unit of the mining machine 105. However, in other embodiments, an accelerometer 115 is fitted to two wheel units of the mining machine 105 (i.e., on opposite sides of the mining machine 105, such as a left front or back wheel and a right front or back wheel). By fitting the accelerometers 115 to the wheels or wheel units, the accelerometers 115 measure the direct effects of the road, which means that a road condition is directly measure inclusive of the dampening effects of the wheel. Also, placing an accelerometer 115 on each side of the mining machine 105 (e.g., left and right) allows the accelerometers 115 to independent measure the road conditions on each side of the road. This configuration of accelerometers 115 can also be used on suspension and non-suspension vehicle because mounting the accelerometers 115 on a wheel or wheel unit eliminates the effects of the suspension and allows for a directly measuring the effect of the road on the wheel.

The accelerometers 115 may also be mounted at other locations on the mining machine 105. For example, one or more accelerometers 115 may be mounted on a chassis of the mining machine 105. Mounting an accelerometer 115 on the chassis may simply wiring of the accelerometer 115 as compared to mounting the accelerometer 115 on the wheel or wheel unit. This mounting configured may also be used with suspended and non-suspended vehicles. For example, for a suspended vehicle, the accelerometers 115 may be mounted above any non-suspended axel and far from any suspended axel and far apart from left-to-right. Also, on suspension vehicle, there is no increase in the vehicle's unsprung mass and, therefore, no decreasing effect on the suspension. Furthermore, in this mounting configuration, the accelerometers may be mounted closer to the edge (e.g., front, back, left, or right) of the mining machine 105 to enhance the effect of the road on the accelerometer 115 (e.g., to counteract lack of sensor sensitivity). Similarly, an accelerometer 115 may be mounted closer to the center of the mining machine 105 to limit the effect of the road on the accelerometer 115 (e.g., prevent the sensor from saturating or reaching the limits of the sensor). However, mounting the accelerometers 115 off of the wheel or wheel units may measure road conditions inclusive of both the dampening effects of the wheels and the suspension, which may not be as accurate as measuring acceleration at the wheels or wheel units. In some embodiments, mathematical models may be developed to counteract the effect of the suspension.

Also, in some embodiments, a single accelerometer 115 may be used to report road conditions on one side of the mining machine 105 or an average of both side if the accelerometer 115 is mounted in a center of the mining machine 105 (e.g., if the mining machine is a non-suspension vehicle). For example, if an accelerometer 115 is a two-axis accelerometer (i.e., it detect acceleration in two axes), the accelerometer 115 may be used to determine a tilt of the mining machine 105 from left-to-right, which can be used to determine whether road conditions vary from left-to-right.

The memory 110 includes a non-transitory, computer-readable medium (e.g., read-only memory (“ROM”), random access memory (“RAM”), and the like). As described below, in some embodiments, the memory 110 stores sensor data generated by the accelerometer 115. In some embodiments, the memory 110 also stores data regarding the mining machine 105, such as speed, location, and the like.

The output interface 120 outputs data to devices and networks external to the mining machine 105. For example, as illustrated in FIG. 1, the output interface 120 may output data over a communication network 125. The communication network 125 may include a wide area network, such as the Internet, a local area network, or the like, employing any of a variety of communications protocols, such as Wi-Fi, Bluetooth®, ZigBee, and the like. In some embodiments, the output interface 120 includes a transmitter for wirelessly transmitting data over the communication network 125. Alternatively or in addition, the output interface 120 includes a port for receiving a wired connection (e.g., a cable, such as an Ethernet cable) to the communication network 125.

In some embodiments, the output interface 120 outputs data stored in the memory 110. For example, in some embodiments, the memory 110 stores sensor data generated by the accelerometer 115, data regarding the mining machine 105, or a combination thereof. This data may be stored in the memory 110 until the communication network 125 is available. When the communication network 125 is available, the output interface 120 outputs the data stored in the memory 110 over the communication network 125. Accordingly, the memory 110 may act as a buffer for data output by the output interface 120, long-term storage for data, or both. Also, in some embodiments, the output interface 120 may output data that was not previously stored to the memory 110.

Data output through the output interface 120 may be output in a raw form, a processed form, or a combination thereof. For example, the data may be encrypted, compressed, filtered, averaged, and the like. Also, in some embodiments, data output by the output interface 120 may be received from multiple sources, such as multiple memories or multiple devices. For example, in some embodiments, the data output through the output interface 120 includes sensor data generated by the accelerometer 115, location data generated by a position detecting device (e.g., a global positioning system (“GPS”) receiver (if such signals are available in the mining environment, a radio-frequency transceiver, a radar transceiver, a dead-reckoning device, and the like) associated with (e.g., included in) the mining machine 105, and speed data generated by a speed sensor included in the mining machine 105. In some embodiments, the data output through the output interface 120 may also include direction data indication a direction of the speed of the mining machine 105 (e.g., to indicate a velocity of the mining machine). In some embodiments, a speed sensor included in the mining machine 105 may provide both the speed data and the direction data.

The electronic processor 117 may include a microprocessor, application specific integrated circuit, or other electronic device that executes instructions (e.g., stored in the memory 110). In particular, the electronic processor 117 executes instructions to read data from the accelerometer 115 and store data to the memory 110. In some embodiments, the electronic processor 117 also executes instructions to read data from the memory 110 and output the data over the output interface 120 as described above.

In some embodiments, the electronic processor 117 executes instructions to store each data read from the accelerometer 115. Alternatively, the electronic processor 117 may execute instructions to read data from the accelerometer and process the read data prior to storage in the memory 110 (or transmission through the output interface 120). For example, the electronic processor 117 may execute instructions (i.e., a data logger) that read output from the accelerometer 115 at a sample rate representing the time between consecutive value reads from the accelerometer 115. The data logger processes and summarizes the samples at a control loop rate that represents a time over which read samples are read, processed, summarized, and logged to the memory 110. In some embodiments, the control loop rate is less than the sample rate. For example, in some embodiments, the first sample rate is approximately 1 to 10 milliseconds and the second sample rate is approximately 50 milliseconds. The processed and summarized samples may include a maximum acceleration value for one or more axes, a minimum acceleration value for one or more axes, an average of positive acceleration values in an axis for one or more axes, an average of negative acceleration values in an axis for one or more axes, an average acceleration value for an axis for one or more axes, and a maximum vector.

In some embodiments, the maximum vector is calculated using the following Equation (1):

Vector=\sqrt{X²+Y²+Z²} (1)

To eliminate some unnecessary calculations, the square root operation may be omitted and the following Equation (2) may be used

Vector=Xₐ²+Yₐ²+Zₐ² (2)

In Equation (2), Xₐ represents sample a of accelerometer data in an x-axis, Yₐ represents sample a of accelerometer data in an y-axis, and Zₐ represents sample a of accelerometer data in an z-axis. Accordingly, a vector may be calculated for each sample using Equation (2) and once all of the vectors have been calculated, the vector of the sample with the maximum value is logged as the maximum vector. Alternatively or in addition, the samples (Xₐ, Yₐ, and Zₐ) associated with the maximum vector may be logged.

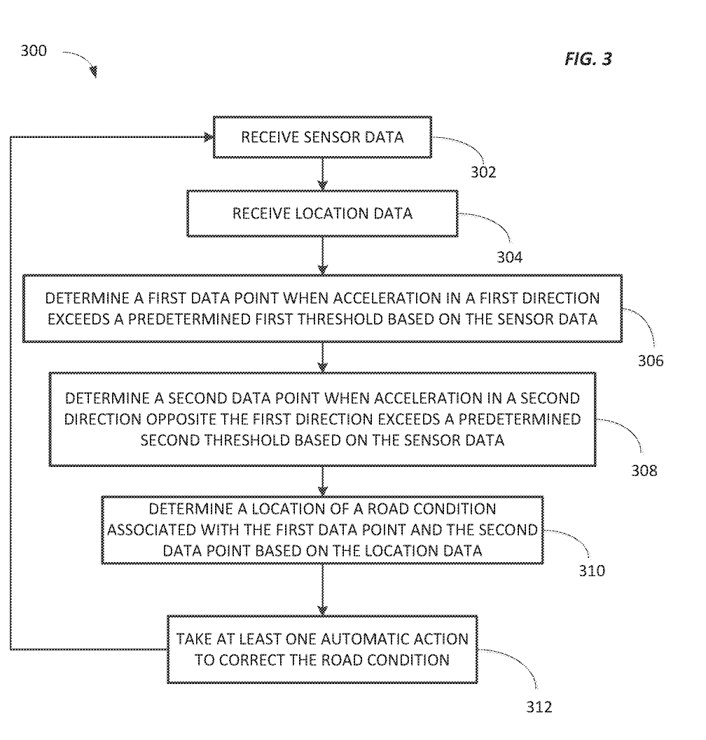

Logging data as described above may limit the amount of data that is logged (i.e., stored to the memory 110). Furthermore, logging data as described may limit the amount of data that needs to be conveyed to the controller 130 and processed by the controller 130 as described below. The sample rate and the control loop rate may be adjusted to suit field conditions, hardware, and sensor and controller limitations. Also, as described in more detail below with respect to FIG. 3, the processed sample data still provides a maximum acceleration value in one or more axes, a minimum acceleration value in one or more axes, an average positive acceleration value and a negative acceleration values for one or more axes, and a maximum vector. From this data, a maximum difference in an axis may be calculated (e.g., maximum acceleration value minus minimum acceleration value). Also, from this data, a maximum difference from an average acceleration value may be calculated for an axis (e.g., maximum acceleration value minus average acceleration value and average value minus minimum acceleration value). Furthermore, from this data, the maximum vector may be evaluated and compared between samples. Accordingly, as described below with respect to FIG. 3, that sensor data received by the controller 130 may include the sampled data read from the accelerometer, the processed and summarized data as described above, or a combination thereof In other words, the plurality of data points described below may include samples read from the accelerometer, processed and summarized samples generated by the electronic processor 117, or a combination thereof.

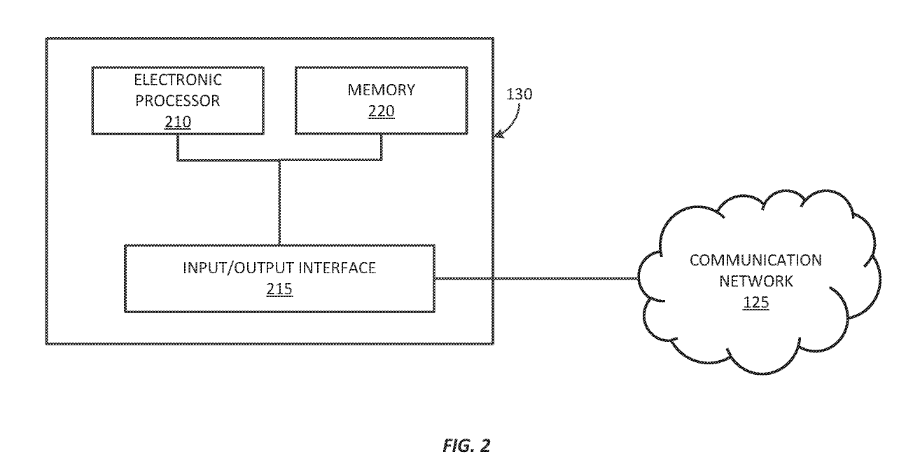

As illustrated in FIG. 1, a controller 130 also communicates with the communication network 125 and receives data output by the output interface 120. As illustrated in FIG. 1, in some embodiments, the controller 130 is located external to the mining machine 150. However, in other embodiments, the controller 130 may be included in the mining machine 105. Also, in some embodiments, all or a portion of the functionality performed by the controller 130 described herein may be performed by the electronic processor 117. FIG. 2 schematically illustrates the controller 130 according to one embodiment. The controller 130 may include an electronic processor 210, a memory 220, and an input/output interface 215. The electronic processor 210, the memory 220, and the input/output interface 215 are connected by and communicate through one or more communication lines. The controller 130 may include additional, fewer, or different components. Also, it should be understood that controller 130 as described in the present application may perform additional functionality than the functionality described herein. Also, the functionality of the controller 130 as described herein may be distributed among more than one controller and among more than one electronic processor. Accordingly, functionality described herein as being performed by the electronic processor 210 may be performed by one or more electronic processors included in the controller 130 or external to the controller 130.

The electronic processor 210 may include an application-specific integrated circuit, a microprocessor, or other suitable electronic device. The memory 220 includes a non-transitory, computer-readable medium (e.g., read-only memory (“ROM”), random access memory (“RAM”), or a combination thereof). The memory 220 stores, stores, among other things, instructions executable by the electronic processor 210 to perform the methods described herein. In some embodiments, the memory 220 also stores data received over the communication network 125, including data output by the output interface 120.

The input/output interface 215 communicates with devices and networks external to the controller 130. For example, as illustrated in FIG. 2, the input/output interface 215 communicates with the communication network 125. In particular, the input/output interface 215 may include a transmitter for wirelessly transmitting data over the communication network 125 or a port for receiving a wired connection (e.g., a cable, such as an Ethernet cable) to the communication network 125. Data received by the input/output interface 215 may be stored to the memory 220. In some embodiments, the input/output interface 215 receives data from the communication network 125, outputs data to the communication network 125, or both. Also, in some embodiments, the input/output interface 215 may communicate with other devices or networks external to the controller 130. For example, in some embodiments, the input/output interface 215 communicates with another communication network different from the communication network 125. Alternatively or in addition, the input/output interface 215 may communicate with one or more peripheral devices, such as a display, a keyboard, a mouse, a printer, and the like over a communication network or a dedicated connection.

In some embodiments, in addition to receiving data over the communication network 125 or as an alternative to receiving data over the communication network 125, the controller 130 receives data through a port of the input/output interface 215. For example, in some embodiments, the input/output interface 215 includes a port for receiving a removable memory device, such as a universal serial bus (“USB”) removable memory device. In this embodiments, the mining machine 105 may similarly have a port for receiving the removable memory device and storing data (e.g., from the memory 110) on the removable memory device. Accordingly, the removable memory device may be used to transfer data from the mining machine 105, including data generated by the one or more accelerometers 115, to the controller 130 without using the communication network 125.

As noted above, the electronic processor 210 included in the controller 130 is configured to execute instructions (e.g., stored in the memory 220) to perform a set of functions. This set of functions may include the method 300 of detecting a road condition as illustrated in FIG. 3. Unless explicitly stated, the order and sequence of the method 300 may vary from the illustrated order and sequence. Furthermore, as noted above, portions of the method 300 may be performed by a plurality of electronic processors included in the controller 130 or external to the controller 130. For example, in some embodiments, the method 300 or a portion thereof may be performed by the electronic processor 117 included in the mining machine 105, the electronic processor 210, or a combination thereof

As illustrated in FIG. 3, the method 300 includes receiving, with the electronic processor 210, sensor data from the one or more accelerometers 115 (at block 302). As noted above, the sensor data may be stored in the memory 110 and may be transmitted by the output interface 120 over the communication network 125. Alternatively or in addition, the sensor data may be stored on a removable memory device (e.g., a USB device) connectable to the controller 130 through a port. As described above, the sensor data may include data points indicating an amount of acceleration in one or more directions or axes (e.g., a magnitude and direction of acceleration). In some embodiments, the sensor data may be time-based such that the acceleration indicated by a data point included in the sensor data may be associated with a particular time (e.g., date, time of day, and the like). The associated timing information may be provided by the one or more accelerometers 115 or a separate device in the mining machine 105. As also described above, the sensor data may include data read from the accelerometer 115, processed data read from the accelerometer, or a combination thereof.

As illustrated in FIG. 3, the method 300 also includes receiving location data for the mining machine 105 (at block 304). In some embodiments, as noted above, the location data is generated by a position detecting device associated with the mining machine 150. The position detecting device may use satellite signals, RF signals, radar signals, sonar signals, dead reckoning navigation, other mechanisms for identifying a geographical location of the mining machine 105 within the mining environment.

Optionally, in some embodiments, the method 300 also includes receiving, with the electronic processor 210, speed data and direction data associated with the mining machine 105. As noted above, the speed data, the direction data, or both may be generated by a speed sensor included in the mining machine 105.

As described above, the speed data, direction data, location data, or a combination thereof may be output by the output interface 120 and received by the controller 130 over the communication network 125. Alternatively or in addition, the speed data, direction data, location data, or a combination thereof may be stored to a removable memory device connectable to the controller 130. Also, in some embodiments, the speed data, direction data, location data, or a combination thereof is received from a device separate from the mining machine 105. For example, in some embodiments, a positioning system separate from the mining machine 105 may track the location of the mining machine 105 may provide the location data to the controller 130 through the communication network 125, a separate communication network, a dedicated connection (e.g., a removable memory device), or a combination thereof

The method 300 also includes determining, with the electronic processor 210, a first data point when acceleration in a first direction exceeds a predetermined first threshold (in a particular axis, such as a vertical axis) based on the sensor data (at block 306). As noted above, the sensor data may include a plurality of data points representing accelerations over a period of time. Accordingly, the electronic processor 210 may be configured to compare the acceleration represented by each data point (or a collection of data points, such as an average acceleration) to the first predetermined threshold to identify a data point associated with an acceleration that exceeds the first predetermined threshold. The first predetermined threshold may vary depending on the environment the mining machine 105 is operating within and other configurable settings.

In some embodiments, the electronic processor 210 may compare the first threshold value to an individual acceleration value. However, as described above, in some embodiments, the electronic processor 117 processes individual acceleration values to provide composite acceleration values (e.g., a minimum acceleration value, a maximum acceleration value, an average acceleration value, and the like). Accordingly, in some embodiments, the electronic processor 210 may compare the first threshold value to such a composite value. For example, the electronic processor 210 may compare a maximum acceleration value to the first threshold value, may compare a difference between a maximum acceleration value and a minimum acceleration value to the first threshold value, may compare a difference between a maximum acceleration value and an average acceleration value to the first threshold, or may compare a difference between a minimum acceleration value and an average acceleration value to the first threshold to identify the first data point. Similarly, the electronic processor 210 may compare the maximum vector to the first threshold value to identify the first data point.

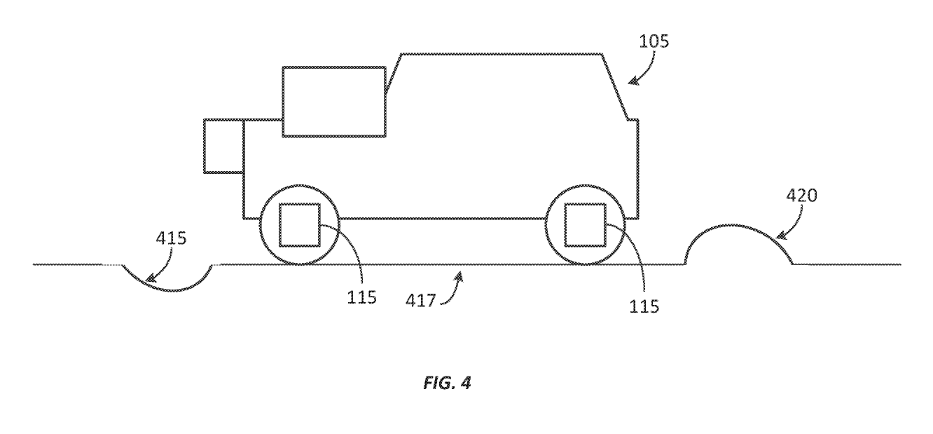

In addition, the method 300 includes determining, with the electronic processor 210, a second data point when acceleration in a second direction opposite the first direction exceeds a predetermined second threshold based on the sensor data (at block 308). For example, after identifying the first data point, the electronic processor 210 may look for a subsequent data point (i.e., a data points occurring in time after the first data point) that is associated with an acceleration that exceeds a second threshold and is in a direction generally opposite the first direction. In particular, as illustrated in FIG. 4, when the mining machine 105 passes over or through a poor road condition, such as a pothole 415, the accelerometer 115 will first register acceleration in the downward direction (as the mining machine 105 drops into the pothole 415) and then register acceleration in the upward direction (as the mining machine 105 exits the pothole 415 and return to the road surface 417). Similarly, when the mining machine 105 passes over an upward step 420, the accelerometer 115 will first register acceleration in the upward direction (as the mining machine 105 passes up the step 420) and then, depending on the speed of the mining machine 105, acceleration in the downward direction (as the mining machine 105 transitions from the step 420 back to the road surface 417). Accordingly, the electronic processor 210 is configured to identify these conditions by comparing detected acceleration to particular thresholds, timing sequences, or both. Also, it should be understood that mining machine 105 may be fitted with multiple accelerometers 115, which may be used to track road conditions (e.g., by comparing with a first accelerometer positioned at the front of the mining machine enters a pothole and when a second accelerometer positioned at the rear of the equipment enters the same pothole). Thus, identifying a particular sequence of extreme accelerations may identify potholes, steps, or other road conditions. As noted above for the first predetermined threshold, the second predetermined threshold may vary depending on the environment the mining machine 105 is operating within and other configurable settings. Also, in some embodiments, the second predetermined threshold may generally equal to, greater than, or less than the first predetermined threshold.

The method 300 also includes determining, with the electronic processor 210, a location associated with the determined distance based on the location data (at block 310). For example, the electronic processor 210 may use the location data to identify where the mining machine 105 was located when it experienced the road condition indicated by the first data point and the second data point. In some embodiments, the electronic processor 210 may identify a first location of the mining machine 105 at the time associated with the first data point and a second location of the mining machine 105 at the time associated with the second data point. The line connecting the first location and the second location (as adjusted based on the direction data) represents the location associated with the detected road condition.

The method 300 also includes taking, with the electronic processor 210, at least one automatic action to correct the detected road condition (at block 312). In some embodiments, the automatic action includes generating an electronic notification (e.g., an email message, text message, automated voice message, and the like) that includes the determined location. The electronic processor 210 may transmit the electronic notification to one or more devices, such as a mobile phone, mobile radio, tablet computer, and the like, operated by maintenance personnel for the mining environment of the mining machine 105 (e.g., over one or more communication networks). The electronic notification informs the maintenance personnel of the location of the detected road condition. The electronic notification may also inform the maintenance personnel of other details of the detected road condition (e.g., type of road condition (pothole, step, etc.), distance, depth, or other measurement of the road condition, and the like).

Alternatively or in addition, the automatic action may include generating an alert (e.g., a visual alert, an audible alert, a tactile alert, or a combination thereof) within the mining environment or outside of the mining environment. For example, in some embodiments, different output devices (e.g., speakers, lights, etc.) positioned throughout the mining environment may be activated based on the determined location. Maintenance personnel may then respond to alerts to repair detected road conditions.

Alternatively or in addition, the automatic action may include adding the location to a graphical map of the mining environment of the mining machine 105. For example, a graphical map (two-dimensional or three-dimensional) may be displayed on a display device for the mining environment. The map may illustrate roads within the mining environment and may also include one or more graphical or textual indicators for detected road conditions. For example, the electronic processor 210 may transmit data to another device that generates and displays the map. The data transmitted by the electronic processor 210 may indicate the location of the detected road condition and, optionally, other details of the detected road condition. Therefore, the map generated and displayed by the other device can be automatically updated with the detected road condition. For example, a graphical or textual indicator may be automatically added to the map at a position representing the location of the detected road condition. The graphical or textural indicator may also be based on the details of the road condition. For example, the distance the detected road condition spans may impact the label, the color, the shape, the size, the animation, or a combination thereof of the indicator added to the map. Similarly, the depth of the detected road condition may impact the label, color, shape, size, or animation of the indicator added to the map. In some embodiments, the electronic processor 210 may be configured to generate the map, display the map or both, which may mean that the electronic processor 210 does not need to transmit data regarding the detected road conditions to another device to update the map.

Alternatively or in addition, the automatic action may include storing data (e.g., the determined location and, optionally, details regarding the road condition associated with the location) in a memory accessible by one or more devices. For example, the data may be stored on an application server that allows devices (e.g., mobile devices, mobile radio, tablet computers, and the like) to access the data (e.g., using a browser application or specialized application executable by the device). Similarly, in some embodiments, the stored data may be used to generate one or more reports, such as tracking changing road conditions over time. Also, in some embodiments, the stored data may be combined with other information associated with the mining machine (e.g., production times or amounts) to associate (e.g., develop a relationship with) road conditions with mining cost data, production data, or both.

In some embodiments, the electronic processor 210 may be configured to rank a detected road condition, such as based on the location, distance, depth, and type of the detected road condition. For example, the ranking may indicate an order of repair such that road conditions with a higher ranking should be addressed by maintenance personnel before road conditions with lower rankings. This ranking information may be included in an electronic notification generated by the electronic processor 210, an alert generated by the electronic processor 210, or included as the data used to update the graphical map of the mining environment (e.g., indicators for road conditions with ranking exceeding a threshold may flash, change color, or otherwise be distinguished from other indicators).

In some embodiments, the electronic processor 210 may determine details of a detected road condition and use the details to determine whether to take an automatic action or, as noted above, what automatic action to take. For example, in some embodiments, the electronic processor 210 is configured to determine a distance (e.g., a width) of a detected road condition. The electronic processor 210 may use the location data to determine the distance. In other embodiments, the electronic processor 210 may use received speed data and direction data to determine the distance. The electronic processor 210 may determine the distance based on the times associated with each data point, the speed of the mining machine 105 at or between the times (e.g., an average speed between the times), and a direction of travel of the mining machine 105 at or between the times).

The electronic processor 210 may compare the determined distance to a predetermined distance. For example, in some embodiments, a pothole may be detected based on the first data point and the second data point. However, the distance traveled by the mining machine 105 between the data points may be so small that repairing or correcting the pothole may not be worthwhile. On the other hand, in some embodiments, the distance between the first data point and the second data point may be so large that the first data point and the second data point do not indicate a pothole by rather bumps at different locations that may not need repair. Accordingly, the electronic processor 210 may compare the determined distance to a minimum distance, a maximum distance, or both to filter detected road conditions and rule out road conditions that may not warrant repair. Also, in some embodiments, the electronic processor 210 uses the determined distance to rank detected road conditions (e.g., the wider the road condition, the higher the rank). The predetermined distances used for comparison to the determined distance may vary depending on the environment the mining machine 105 is operating within and other configurable settings.

Also, in some embodiments, in addition to or as an alternative to detecting locations of road conditions warranting repair based on the first data point and the second data point, the electronic processor 210 may be configured to classify a road within the mining environment or a portion thereof based on the sensor data. For example, the electronic processor 210 may be configured to analyze the sensor data in the vertical up direction and in the vertical down direction independently over a predetermined or adjustable period of time to determine a metric, such as (i) a maximum acceleration, (ii) an average of the greatest N accelerations (where N is an adjustable parameter), (iii) a number of accelerations above a predetermined threshold, or a combination thereof. In particular, the electronic processor 210 may be configured to determine a metric that includes a maximum change in acceleration (e.g., up-to-down or down-to-up) over a predetermined or adjustable period of time. The controller 130 uses the metric (or a derivation of the metric, such as an average, median, and the like of the metric or a normalized version of the metric) to define a score indicating road conditions. Accordingly, in this embodiment, a road or individual portions of a road may be assigned a score indicating how good or poor road conditions are. These scores may be included in electronic notifications, alerts, maps, reports, and rankings as described above. Similarly, the first data points and second data points described above may be used to detect poor road conditions and the number of poor road conditions detected for a particular road or portion of a road may be used to generate the score for the road or portion of the road. For example, the electronic processor 210 may be configured to determine a plurality of first data points and a plurality of second data points, determine a number of the plurality of locations, and generate a score for the road condition based on the number of the plurality of locations.

Also, in some embodiments, the sensor data may be combined with other data regarding the mining machine 105, such as the speed of the mining machine 105 and a suspension of the mining machine 105 (e.g., a turning radius of the mining machine 105) to detect road conditions. For example, speed, suspension, or other data regarding the mining machine 105 may be combined with the sensor data to normalize the sensor data with regard to mining machine-specific parameters, such as speed and suspension state.

In some embodiments, the sensor data received from an accelerometer 115 coupled to the mining machine 105 may be combined with sensor data received from accelerometers coupled to other mining machines operating within the mining environment. For example, sensor data associated with multiple mining machines may be combined to generate more accurately or reliably detect road conditions. For example, sensor data from multiple mining machines may be combined to generate average scores or rankings as described above.

Accordingly, embodiments of the invention use sensor data from the one or more accelerometers to identify locations along an underground road where high accelerometer readings are registered. These locations represent areas where mining machines are subjected to high impacts due to poor road conditions. As noted above, these areas may be flagged in reports, which may be used by maintenance personnel to repair the road or, alternatively, may be used to identify personal operating mining machines within the mining environment that need to be retrained (e.g., in situations where improper mining operations caused the poor road conditions). For example, the sensor data may be used to set criteria for categorizing good roads versus bad roads (e.g., for maintenance schedule, route planning, etc.), to provide mining customers with comprehensive information regarding mining environments and associated costs and risks, to alert personnel when corrective actions should be taken to address poor road conditions, to prioritize road repairs (e.g., based on the severity of road conditions or the frequency of travel of poor road conditions), to evaluate road maintenance methodologies, to reinforce good road maintenance behavior, to evaluate the comparative mining machine maintenance cost of poor versus good road conditions, to prevent premature failures and increase component lifetime, to reduce maintenance costs, to increase production and production efficiency (e.g., reduce breakdowns, allow for faster equipment speeds due to good road conditions, etc.), and reduce road inspections and associated costs including labor.

Various features and advantages of the invention are set forth in the following claims.

1. A system comprising:
an accelerometer coupled to a mining machine; and
an electronic processor configured to:
receive sensor data from the accelerometer,
receive location data associated with the mining machine,
determine a first data point when acceleration in a first direction exceeds a predetermined first threshold based on the sensor data,
determine a second data point when acceleration in a second direction opposite the first direction exceeds a predetermined second threshold based on the sensor data,
determine a location of a road condition represented by the first data point and the second data point based on the location data,
determine personnel operating one or more mining machines within the underground mining environment at the location of the road condition represented by the first data point and the second data point, and
automatically generate and transmit an electronic notification over at least one communication network, the electronic notification indicating the personnel and the location.

2. The system of claim 1, wherein the electronic processor is further configured to receive speed data and direction data associated with the mining machine and determine a distance traveled by the mining machine between the first data point and the second data point based on the speed data and the direction data.

3. The system of claim 2, wherein the electronic processor is further configured to compare the distance to a predetermined distance, and automatically generate and transmit the electronic notification when the distance satisfies the predetermined distance.

4. The system of claim 1, wherein the electronic processor is configured to receive the location data generated by a position detecting device associated with the mining machine.

5. The system of claim 1, wherein the electronic processor is further configured to rank the road condition based on the location, a distance, a depth, or a type of the road condition.

6. The system of claim 5, wherein the electronic notification includes the rank of the road condition.

7. The system of claim 1, wherein the accelerometer is coupled to an underside of the mining machine.

8. The system of claim 1, wherein the accelerometer includes a micro electro-mechanical accelerometer.

9. The system of claim 1, wherein the electronic processor is configured to receive the sensor data over the at least one communication network or from a removable memory device.

10. A method of detecting a road condition of an underground mining environment, the method including:
receiving, with an electronic processor, sensor data from an accelerometer coupled to a mining machine operating within the underground mining environment;
receiving, with the electronic processor, location data associated with the mining machine generated by a position detecting device associated with the mining machine;
receiving, with the electronic processor, suspension data associated with the suspension of the mining machine;
determining, with the electronic processor, normalized sensor data based on the suspension data;
determining, with the electronic processor, a first data point when acceleration in a first direction exceeds a predetermined first threshold based on the normalized sensor data;
determining, with the electronic processor, a second data point occurring in time after the first data point when acceleration in a second direction opposite the first direction exceeds a predetermined second threshold based on the normalized sensor data;
determining, with the electronic processor, a location of a road condition associated with the first data point and the second data point based on the location data; and
automatically updating, with the electronic processor, a graphical map of the mining machine with an indicator associated with the location of the road condition.

11. The method of claim 10, wherein automatically updating the graphical map with the indicator includes generating the indicator based on a ranking of the road condition and adding to the indicator to the graphical map at a position within the graphical map corresponding to the location.

12. The method of claim 10, wherein automatically updating the graphical map with the indicator includes modifying a label, a color, a shape, a color, or an animation of the indicator based on a ranking of the road condition.

13. The method of claim 10, further comprising determining a ranking of the road condition based on the location, a distance, a depth, or a type of the road condition.

14. The method of claim 10, further comprising identifying a plurality of locations by determining a plurality of first data points and a plurality of second data points, determining a number of the plurality of locations, and generating a score for the road condition based on the number of the plurality of locations.

15. A method of detecting road conditions within an underground mining environment, the method comprising:
receiving, with an electronic processor, sensor data from an accelerometer coupled to a mining machine operating within the underground mining environment;
receiving, with the electronic processor, location data associated with the mining machine generated by a position detecting device associated with the mining machine;
determining, with the electronic processor, a metric based on the sensor data, wherein the metric includes a number of accelerations above a predetermined threshold during the period of time;
determining, with the electronic processor, a score based on the metric or a derivation of the metric;
assigning, with the electronic processor, the score to at least a portion of a road within the underground mining environment based on the location data; and
outputting, with the electronic processor, the score assigned to the portion of the road.

16. The method of claim 15, wherein outputting the score includes adding the score to a graphical map of the underground mining environment.

17. The method of claim 15, further comprising normalizing the metric based on speed data of the mining machine or a suspension state of the mining machine.

18. The method of claim 15, wherein outputting the score includes identifying personnel operating one or more mining machines within the underground mining environment needing retraining.

19. The method of claim 15, wherein outputting the score includes combining the score with production data or cost data for the underground mining environment to develop a relationship between the score and the production data or the cost data.
